(19) United States
(12) Patent Application Publication
(10) Pub. No.: US 2017/0011668 A1
(43) Pub. Date: Jan. 12, 2017

(54) EXHIBITOR IDENTIFIER DISPLAY SYSTEM

(71) Applicant: Erwin Bruner, Wellington, FL (US)

(72) Inventor: Erwin Bruner, Wellington, FL (US)

(21) Appl. No.: 15/273,979

(22) Filed: Sep. 23, 2016

Related U.S. Application Data
(63) Continuation-in-part of application No. 13/150,861, filed on Jun. 1, 2011, now abandoned.
Application No. 13/150,861 is a continuation-in-part of application No. 12/614,133, filed on Nov. 6, 2009, now abandoned.

(51) Int. Cl. G09F 7/02; B68C 1/12; G09F 7/18

(52) U.S. Cl. CPC G09F 7/02; G09F 7/18; B68C 1/12; G09F 2007/1873

(57) ABSTRACT

An equestrian identification system including a series of character presentation panels attached to a panel receiving patch. A dense hook interface is provided upon an interface surface of the character presentation panels. A dense loop interface is provided upon an interface surface of the panel receiving patch. The panel receiving patch is applied to an area of a saddle pad, an equestrian's attire, or other object. One character image is provided upon a viewing surface of each respective character presentation panel. The character image is selected from an image group, where the image group consists of a set of numbers within a range of 0 through 9, a set of alphabet letters within a range of A through Z, and a complete set of grammatical characters included within ASCII code languages. The panel receiving patch can be colored to compliment the object to which is it being applied thereon.

### CROSS-REFERENCE TO RELATED APPLICATIONS

This application is a Continuation-in-Part patent application under 35 U.S.C. §120 of U.S. patent application Ser. No. 13/150,861 filed Jun. 1, 2011 and U.S. patent application Ser. No. 12/614,133 filed Nov. 6, 2009, which applications are incorporated herein by reference.

### FIELD OF THE INVENTION

The invention broadly relates to an apparatus and method for identifying an equestrian participant. More particularly, the present disclosure relates to a numbering apparatus for changeably displaying a series of digits for an equestrian event.

### BACKGROUND OF THE INVENTION

Identification systems are used in competitive sports including, but not limited to, dressage, endurance riding, eventing, reining, show jumping, tent pegging, vaulting, polo, horse racing, driving, and rodeo. Some popular forms of competition are grouped together at horse shows, where horses perform in a wide variety of disciplines.

There are many types of Equestrian events. Sporting events are substantiated When they are included in the Olympic Games. Equestrian events were first included in the Olympic Games in 1900. By 1912, all three Olympic disciplines, still seen today, were part of the games. The following forms of competition are recognized worldwide and are a part of the equestrian events at the Olympics:
Dressage (“training” in French) involves the progressive training of the horse to a high level of impulsion, collection, and obedience. Competitive dressage has the goal of showing the horse carrying out, on request, the natural movements that it performs without thinking while running loose. One dressage master has defined it as “returning the freedom of the horse while carrying the rider.”
Show jumping comprises a timed event judged on the ability of the horse and rider to jump over a series of obstacles, in a given order and with the fewest refusals or knockdowns of portions of the obstacles.
Eventing, also called combined training, horse trials, the three-day event, the Military, or the complete test, puts together the obedience of dressage with the athletic ability of show jumping, the fitness demands the cross-country jumping phase. In the last-named, the horses jump over fixed obstacles, such as logs, stonewalls, banks, ditches, and water, trying to finish the course under the “optimum time,” There was also the ‘Steeple Chase’ Phase, which is now excluded from most major competitions to bring them in line with the Olympic standard.

Additional events sanctioned by the EEL as international disciplines include combined driving, reining, equestrian vaulting, endurance riding and Paralympic competition. While these events are recognized internationally and are all part of the EEL World Equestrian Games, none are yet part of the Summer Olympics, though some, such as vaulting and reining, are potentially on track to be added.

Participants of the various equestrian events are identified by a numeric identifier. The numeric identifier is generally a series of three (3) or four (4) numeric digits displayed upon a saddle pad. The printed display sheets are pre-printed, with a pair of matching sheets provided to the participant at the start of an event. The standard practice is to provide the participant with a printed display sheet that is inserted into a transparent sleeve. The printed display sheet is normally paper, which is subject to damage when wet. The sleeves can discolor or tear. Alternately, the display sheets can be pinned to the saddle pads, which risks tearing during the event.

Thus, there is a long-felt need for a numeric identifier, which is weatherproof, available to the participant in advance, and is secured throughout the event.

### BRIEF SUMMARY OF THE INVENTION

The present invention broadly comprises a device and respective system for identifying an equestrian event participant.

In some embodiments, the identification system may include: a panel receiving patch comprising a dense loop interface provided on an interface side of said receiving patch, said panel receiving patch is designed to be attached to an equestrian object; and a series of character presentation panels, said series comprising at least one of: a character image disposed upon a panel image presentation surface of each character presentation panel, respectively to form a set of character images, said set of character images are selected from a character image group, said character image group comprising: a set of numbers within a range of 0 through 9, a set of alphabet letters within a range of A through Z, and a complete set of grammatical characters included within ASCII code languages; and each character presentation panel comprises a dense hook interface on an attachment side of said character presentation panel.

While in another aspect, one image in different orientation to represent two distinct characters.

In another aspect, the series of numbered panels comprise a set of numbered panels being numbered between 0 and 8, wherein the 6 and the 9 are interchangeable.

In still another aspect, the series of numbered panels comprise a plurality of sets of numbered panels, each set being numbered between 0 and 8.

In another aspect, the series of character identification panels comprise a set of character identification panels, wherein the “L” and the “I” are interchangeable.

In yet another aspect, the series of character identification panels comprise a set of character identification panels, wherein the “I” and the “I” are interchangeable.

While yet another aspect places a plurality of characters identification panels adjacent each other.

In yet another aspect, the images of the characters are printed upon an exposed surface of the character identification panels.

In a still further aspect, the images of the characters are embroidered upon the character identification panels.

In a still further aspect, each character identification panel comprises an image of a character applied upon a smooth side and a dense hook surface on an opposite side.

In another aspect, the panel receiving patch is colored to match the surface in which it is to be applied upon.

Continuing with another aspect, the panel receiving patch is applied to a saddle pad.

In a still further aspect, the panel receiving patch is applied to an equestrian riding jacket.

In yet another aspect, the panel receiving patch is applied to a sleeve or rear of the equestrian riding jacket.

These and other aspects, features, and advantages of the present invention will become more readily apparent from the attached drawings and the detailed description of the preferred embodiments, which follow.

### BRIEF DESCRIPTION OF THE DRAWINGS

The nature and mode of operation of the present invention will now be more fully described in the following detailed description of the invention taken with the accompanying drawing figures, in which:

FIG. 1 is a perspective view of a horse having a participant numeric identifier in accordance with the known prior art;

FIG. 2 is a side elevational view of an exemplary participant numeric identifier in accordance with the present invention;

FIG. 3 is a side elevational view of a saddle pad including the participant numeric identifier of FIG. 2;

FIG. 4 is a perspective view of an equestrian participant including the participant numeric identifier of FIG. 2; and,

FIG. 5 is a side elevational view of an exemplary participant character identifier in accordance with the present invention.

### DETAILED DESCRIPTION OF THE INVENTION

At the outset, it should be appreciated that like drawing numbers on different drawing views identify identical, or functionally similar, structural elements of the invention. While the present invention is described with respect to what is presently considered to be the preferred aspects, it is to be understood that the invention as claimed is not limited to the disclosed aspects.

Furthermore, it is understood that this invention is not limited to the particular methodology, materials and modifications described and, as such, may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. It should be appreciated that the term “substantially” is synonymous with terms such as “nearly”, “very nearly”, “about”, “approximately”, “around”, “bordering on”, “close to”, “essentially”, “in the neighborhood of”, “in the vicinity of”, etc., and such terms may be used interchangeably as appearing in the specification and claims. Although any methods, devices or materials similar or equivalent to those described herein can be used in the practice or testing of the invention, the preferred methods, devices, and materials are now described.

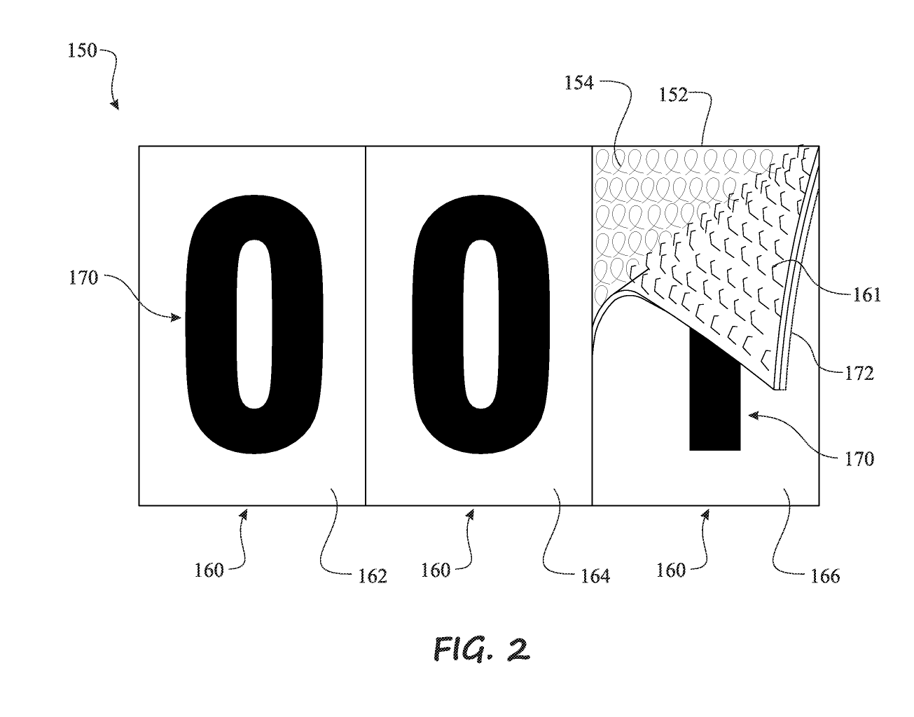

As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in FIG. 2.

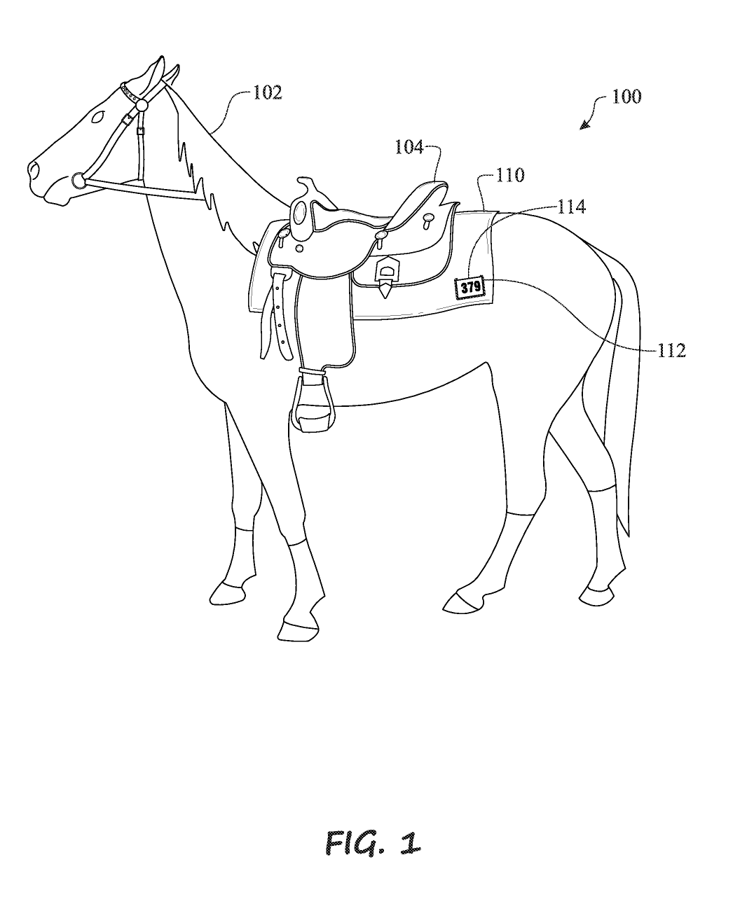

Equestrian sports identify the participants via a numeric identifier. The judges or scoring parties rely of the numeric identifier as a means for identifying the participants or equestrian sporting horses 100 as presented in exemplary illustration of FIG. 1. The equestrian sporting horse 100 is a horse 102 having a saddle 104 placed upon an equestrian sporting horse 100. The currently used identifier is a printed participant identifier 114 inserted into an equestrian participant identifier holder 112 placed upon a saddle pad 110. The printed participant identifier 114 is normally provided as a printed sheet of paper, sized to fit into the equestrian participant identifier holder 112. The equestrian participant identifier holder 112 is preferably provided on each side of the saddle pad 110.

The equestrian participant identifier system 150 provides a numbering identification system comprising a panel receiving patch 152 and a series of numbered panels 160, as illustrated in FIG. 2. Each numbered panel 160 is preferably sized being 2.0″ tall and 1.5″ wide. The preferred panel receiving patch 152 is sized to accept three (3) numbered panels 160 (as shown) or four (4) as understood, being 2″ tall by 4.5″ wide or 2.0″ tall by 6.0″ wide respectively. The panel receiving patch 152 is fabricated having a dense loop interface 154 on an exposed side for removably attaching the numbered panel 160 therefrom. The panel receiving patch 152 can be colored to match or compliment the color of an object Co which the panel receiving patch 152 is to be applied upon. Although the preferred embodiment is dimensioned as stated, it is understood that the panel receiving patch 152 and respective series of numbered panels 160 can be of any reasonable dimension suited for the desired application.

The series of numbered panels 160 includes three (3) (or four as an alternate) sets 162, 164, 166 of numbered panels. Each set of numbered panels are numbered from 0 through 8, wherein the same panel is used for both the “6” and the “9”.

Each numbered panel 160 is formed having a dense hook interface 161 provided upon an attachment side and a numeric image 170 visible from an exposed side. The numeric image 170 includes images representative of the numbers 0 through 8, wherein the same panel is used for both the “6” and the “9”. The numbers can be printed onto the exposed surface, embroidered onto the panels 160, or applied by any other known means. The numbered panel 160 can be a single material having a dense hook interface 161 on the attachment side, and a relatively planar surface on the opposite site. Alternately, the dense hook interface 161 and the exposed surface can be of separate materials that are assembled together forming a single finished unit. The numeric image 170 can be applied to the exposed surface material 172 prior to or subsequent the assembly process.

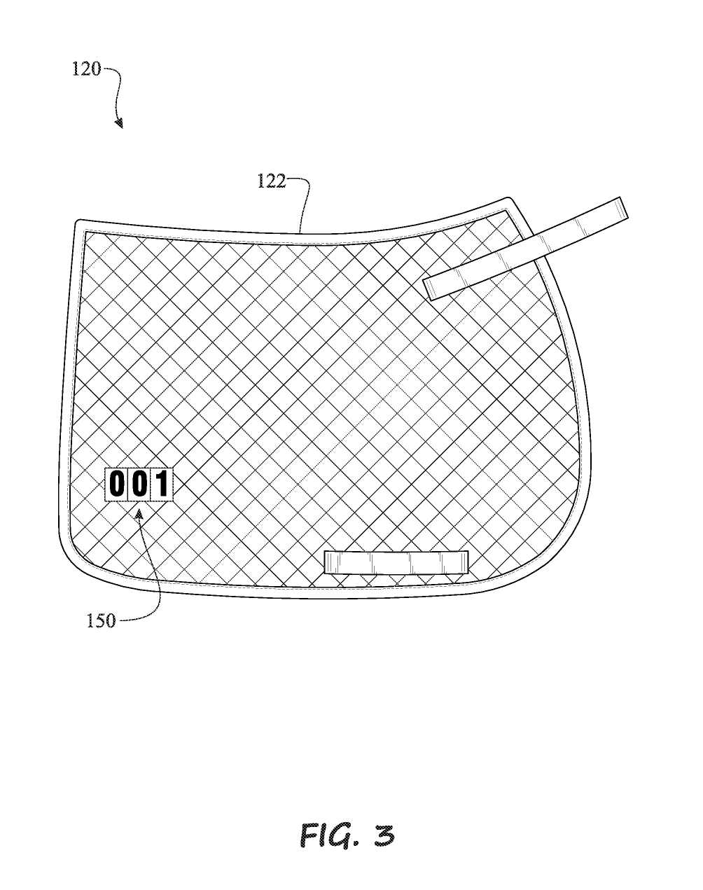

A first exemplary embodiment is presented as a saddle pad assembly 120, being illustrated in FIG. 3. The saddle pad assembly 120 comprises a saddle pad 122 outfitted to adorn the equestrian participant identifier system 150. The panel receiving patch 152 is stitched to, adhered to, or attached via any other attachment means to the saddle pad 122, orienting the dense loop interface 154 outwards for engaging with the dense hook interface 161. The panel receiving patch 152 is positioned to meet the regulation of the international equestrian guidelines.

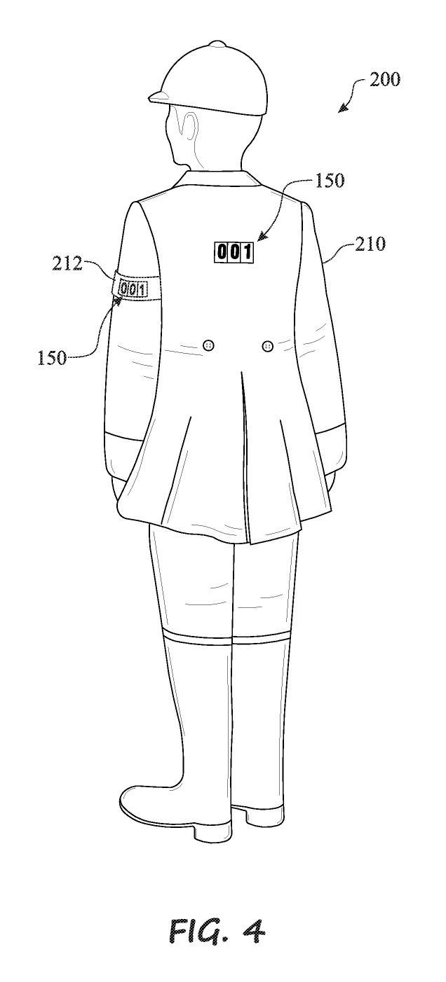

A second exemplary embodiment is presented as an equestrian participant 200, being illustrated in FIG. 4. The equestrian participant 200 is illustrated wearing a participant's attire 210, the participant's attire 210 adorned by the equestrian participant identifier system 150. The panel receiving patch 152 is stitched to, adhered to, or attached via any other attachment means to the participant's attire 210, orienting the dense loop interface 154 outwards for engaging with the dense hook interface 161. The panel receiving patch 152 can be safety pinned to the participant's attire 210, wherein the numbered panels 160 would cover the safety pin. The panel receiving patch 152 is positioned to meet the regulation of the international equestrian guidelines. Since most participants' attire 210 is colored, it is preferable that the panel receiving patch 152 be colored to match or compliment the color of the participant's attire 210. Alternately, the equestrian participant identifier system 150 can be applied to an armband 212 in a similar manner.

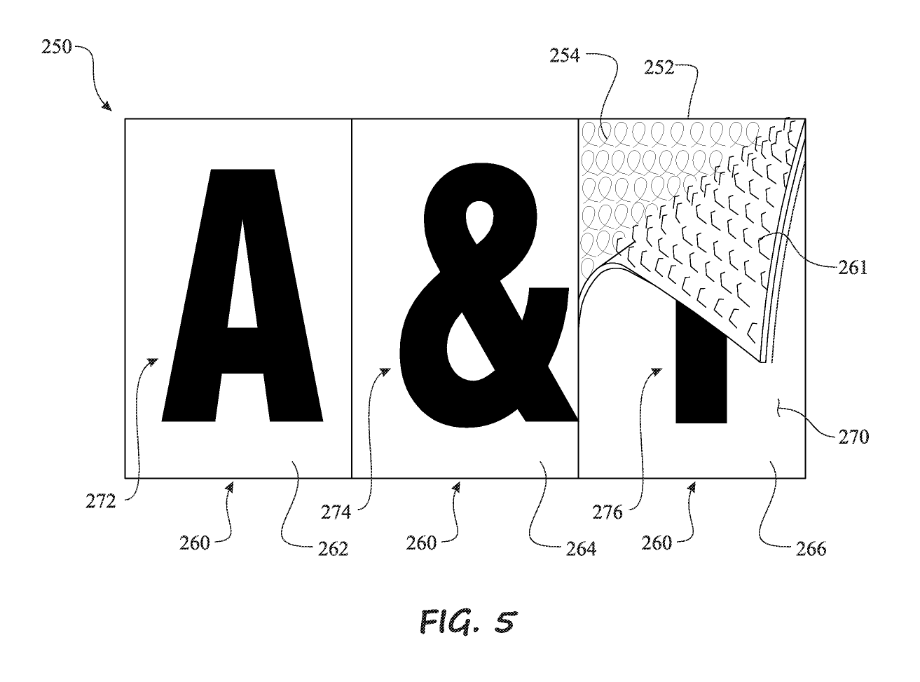

The initial exemplary embodiment presents an equestrian participant identifier system 150 comprising a series of numeric images. A second exemplary embodiment expands the equestrian participant identifier system to include a partial or complete set of alphabetical letters and partial or complete set of grammatical characters as presented in FIG. 5. The enhanced equestrian participant identifier system 250 expands the indicia applied onto the exposed surfaces of the character presentation panels 260. A dense hook interface 261 is carried upon an attachment surface of the character presentation panel 260. Each character presentation panel 260 is preferably sized being 2.0″ tall and 1.5″ wide. The preferred panel receiving patch 252 is sized to accept a quantity of three (3) character presentation panels 260 (as shown) or four (4) as understood, being 2″ tall by 4.5″ wide or 2.0″ tall by 6.0″ wide respectively. The panel receiving patch 252 is fabricated having a dense loop interface 254 on an exposed side for removably attaching the character presentation panels 260 therefrom. The panel receiving patch 252 can be colored to match or compliment the color of an object to which the panel receiving patch 252 is to be applied thereon.

An indicia is presented upon a panel image presentation surface 270 of each character presentation panel 260. The indicium is representative of a specific value or character for recognition of a unique identification system. A series of character presentation panels 260 creates a complete identifier. A first set of panels 262 is representative of a series of panels 260 comprising a portion or complete set of alphabetical letters 272. The set of alphabetical letters 272 would comprise a portion or complete set of alphabetical letters within a range established between A through Z (or the equivalent in any selected language). A second set of panels 264 is representative of a series of panels 260 comprising a portion or complete set of character images 274. The set of character images 274 would comprise a portion or complete set of characters included within ASCII code languages (wherein the characters are respective to any selected language). A third set of panels 266 is representative of a series of panels 260 comprising a portion or complete set of numeric images 276. The set of numeric images 276 would comprise a portion or complete set of numeric values within a range of 0 through 9.

Those skilled in the art would recognize the application of the equestrian participant identifier system 150 or the enhanced equestrian participant identifier system 250 for use in non-equestrian applications. Additional examples of applications can include using the system as an identification system for runners, track and field participants, cyclists, skiers, volleyball players, dog handlers, and the like.

Thus, it is seen that the objects of the present invention are efficiently obtained, although modifications and changes to the invention should be readily apparent to those having ordinary skill in the art, which modifications are intended to be within the spirit and scope of the invention as claimed. It also is understood that the foregoing description is illustrative of the present invention and should not be considered as limiting. Therefore, other embodiments of the present invention are possible without departing from the spirit and scope of the present invention.

What is claimed is:

1. An equestrian participant identifier method, comprising:
obtaining a panel receiving patch, said panel receiving patch comprising a dense loop interface provided on an attachment side of said receiving patch;
obtaining a series of character presentation panels, said series comprising at least one of:
a character image disposed upon a panel image presentation surface of each character presentation panel, respectively to form a set of character images, said set of character images are selected from a character image group, said character image group comprising:
a set of numbers within a range of 0 through 9, a set of alphabet letters within a range of A through Z, and a complete set of grammatical characters included within ASCII code languages; and
each character presentation panel comprises a dense hook interface on an attachment side of said character presentation panel;
applying said panel receiving patch to a saddle pad, said panel receiving patch being oriented having said interface side exposed for receiving at least one character presentation panel;
establishing and associating a unique equestrian participant identifier with each equestrian participant;
removably attaching at least one character presentation panel to said panel receiving patch in an arrangement which replicates said unique equestrian participant identifier to identify said respective equestrian participant during a competition; and,
identifying an equestrian participant using said attached at least one character presentation panel displayed upon said panel receiving patch.

2. An equestrian participant identifier method as recited in claim 1, said method further comprising a step of removably attaching at least two character presentation panels adjacent one another to form an at least two character set.

3. An equestrian participant identifier method as recited in claim 2, said method comprising said steps of:
applying a pair of panel receiving patches, one to each side of said saddle pad;
selecting a pair of at least one character presentation panels, said character presentation panels identifying said unique equestrian participant identifier; and,
removably attaching each of said pair of at least one character presentation panels to each of said two panel receiving patches.

4. An equestrian participant identifier method as recited in claim 1, said method further comprising a step of utilizing one image in different orientation to represent two distinct characters.

5. An equestrian participant identifier method, comprising:
obtaining an equestrian identification kit, the equestrian identification kit comprising:
a panel receiving patch, the patch having a dense loop interface provided on an interface side of said receiving patch, the panel receiving patch being designed to be attached to at least one of an equestrian object applied upon a horse and an apparel worn by a rider; and,
a series of character presentation panels, said series comprising at least one of:
a character image disposed upon a panel image presentation surface of each character presentation panel, respectively to form a set of character images, said set of character images are selected from a character image group, said character image group comprising:
at least one of:
a set of numbers within a range of 0 through 9,
a set of letters within a range of A through Z, and,
a set of complete set of grammatical characters included within ASCII code languages; and,
each character presentation panel comprises a dense hook interface on an attachment side of said character presentation panel;
receiving an assignment of an associated identifier the horse during an equestrian competition occurring at an equestrian event;
selecting the necessary character presentation panels from the at least one of a set of numbers, set of letters, and set of grammatical characters to match the associated identifier;
attaching the panel receiving patch to the equestrian object that is applied upon the horse;
applying the selected set of necessary character presentation panels to the panel receiving patch in an arrangement to replicate the associated identifier; and,
competing in the equestrian competition, wherein judges identify the horse by the set of required character presentation panels applied to the panel receiving patch.

6. An equestrian participant identifier method as recited in claim 5, said method further comprising a step of removably attaching at least two character presentation panels adjacent one another to form an at least two character set.

7. An equestrian participant identifier method as recited in claim 6, said method comprising said steps of:
applying a pair of panel receiving patches, one to each side of said saddle pad;
selecting a pair of at least one character presentation panels, said character presentation panels identifying said unique equestrian participant identifier; and,
removably attaching each of said pair of at least one character presentation panels to each of said two panel receiving patches.

8. An equestrian participant identifier method as recited in claim 5, said method further comprising a step of utilizing one image in different orientation to represent two distinct characters.

9. An equestrian participant identifier method, comprising:
obtaining a pair of equestrian identification kits, each equestrian identification kit comprising:
a panel receiving patch, the patch having a dense loop interface provided on an interface side of said receiving patch, the panel receiving patch being designed to be attached to at least one of an equestrian object applied upon a horse and an apparel worn by a rider; and
a series of character presentation panels, said series comprising at least one of:
a character image disposed upon a panel image presentation surface of each character presentation panel, respectively to form a set of character images, said set of character images are selected from a character image group, said character image group comprising:
at least one of:
a set of numbers within a range of 0 through 9,
a set of letters within a range of A through Z, and,
a set of complete set of grammatical characters included within ASCII code languages; and,
each character presentation panel comprises a dense hook interface on an attachment side of said character presentation panel;
receiving an assignment of an associated identifier respective to the horse and rider during an equestrian competition occurring at an equestrian event;
selecting a first set of necessary character presentation panels from the at least one of a set of numbers, set of letters, and set of grammatical characters to match the associated identifier;
attaching the first panel receiving patch to the saddle pad that is placed upon the horse;
applying the selected set of necessary character presentation panels to the panel receiving patch applied to the saddle pad in an arrangement to replicate the associated identifier;
selecting a second set of necessary character presentation panels from the at least one of a set of numbers, set of letters, and set of grammatical characters to match the associated identifier;
attaching the second panel receiving patches to the rider's attire;
applying the selected set of necessary character presentation panels to the panel receiving patch applied to the rider's attire in an arrangement to replicate the associated identifier; and,
competing in the equestrian competition, wherein judges identify the horse and rider by the set of required character presentation panels applied to the panel receiving patch.

10. An equestrian participant identifier method as recited in claim 9, said method further comprising a step of removably attaching at least two character presentation panels adjacent one another to form an at least two character set.

11. An equestrian participant identifier method as recited in claim 10, said method comprising said steps of:
applying a pair of panel receiving patches, one to each side of said saddle pad;
selecting a pair of at least one character presentation panels, said character presentation panels identifying said unique equestrian participant identifier; and,
removably attaching each of said pair of at least one character presentation panels to each of said two panel receiving patches,

12. An equestrian participant identifier method as recited in claim 9, said method further comprising a step of utilizing one image in different orientation to represent two distinct characters.
